(19) United States
(12) Patent Application Publication
(10) Pub. No.: US 2008/0246984 A1
(43) Pub. Date: Oct. 9, 2008

(54) IMAGE DATA CREATION METHOD AND INFORMATION PROCESSING APPARATUS

(75) Inventor: Atsushi SHOJI, Kawasaki-shi (JP)

Correspondence Address: ROSSI, KIMMS & McDOWELL LLP., P.O. BOX 826, ASHBURN, VA, 20146-0826, US

(73) Assignee: CANON KABUSHIKI KAISHA, Tokyo (JP)

(21) Appl. No.: 12/098,402

(22) Filed: Apr. 4, 2008

(30) Foreign Application Priority Data
Apr. 6, 2007 (JP) 2007-101046

(51) Int. Cl. G06F 15/00

(52) U.S. Cl. 358/1.13

(57) ABSTRACT

An information processing apparatus for creating image data, comprises a setting unit adapted to set an operation condition of a print unit, a generation unit adapted to generate image data having undergone distortion correction by using distortion correction information corresponding to the set operation condition, and a transmission unit adapted to transmit the generated image data and information of the operation condition to the print unit.

### BACKGROUND OF THE INVENTION

1. Field of the Invention

The present invention relates to an image data creation method in an information processing apparatus and the information processing apparatus.

2. Description of the Related Art

In recent years, demands for home use printers adopting an electrophotographic method are increasing, and size reduction, speeding-up, and cost reduction are required along with this. A size-reduced optical system needs to be adjusted at higher precision, and mutual adjustment for color drawing is required, resulting in high adjustment cost. In order to meet both requirements of size reduction and speeding-up, higher precision adjustment cost of an optical system is required, thus disturbing cost reduction. In one approach, in order to reduce cost associated with hardware such as manufacturing cost of mechanism parts and adjustment cost of an optical system, certain nonuniformities such as slight bend, inclination, and the like are permitted, and instead an image to be drawn is corrected by use of software, thus suppressing the total product cost.

A conventional correction example will be explained below. An image forming apparatus which has 5000 pixels in a main scanning direction (z-axis direction) and in which a scan surface suffers distortions for four pixels at the start and terminal end points will be assumed. In consideration of a delay distortion for one pixel due to conveyance of a print sheet, a distortion generated in the conveying direction (y-direction) can be calculated by:

$$\begin{matrix}y = f ( z ) + k z \\ = ( 4 / 5000 + 1 / 5000 ) \cdot z \\ = 1 / 1000 \cdot z\end{matrix} \qquad ( 1 )$$

By correcting a distortion upon changing a scan line to be selected of image data at a coordinate position deviated by a ½ pixel, the first correction point is z=500 (pixels) since ½= 1/1000·z. That is, a scan line is switched at the 500th pixel, and then again at the 1000th, 1500th, 2000th, 2500th, . . . , 4500th pixels.

In case of an image forming apparatus having an operation mode of increasing the print resolution in the conveying direction by lowering the conveying speed of a print sheet, an amount of optimal distortion correction changes undesirably due to a change in conveying speed.

For example, the switching coordinate position of a scan line upon doubling the resolution by halving the conveying speed is calculated as follows. The number of pixels in the main scanning direction (z-axis direction) is doubled, that is, 10000, a skew amount corresponds to eight pixels, and an amount of conveying distortion remains one pixel although it is halved but the pixel density is doubled. Hence, the switching coordinate position is calculated by:

$$\begin{matrix}y = ( 8 / 10000 + 1 / 10000 ) \cdot z \\ = 9 / 10000 \cdot z\end{matrix} \qquad ( 2 )$$

By correcting a distortion upon changing a scan line to be selected of image data at a coordinate position deviated by a ½ pixel, the first correction point at that time is z=555.555 . . . since ½= 9/10000·z. That is, a scan line is switched at the 556-th pixel first, and then again at the 1112th pixel, 1667th pixel, 2223rd pixel, 2778th pixel, etc. When these pixel positions are converted based on the original resolution, the switching coordinate positions in this double density scan are the 278th pixel, 556th pixel, 833rd pixel, 1111th pixel . . . , and do not match the original switching coordinate positions calculated based on equation (1).

In an actual image forming apparatus, the distortions and pressures of a photosensitive drum and other conveying system parts change upon changing the operation speed of a mechanical driving system, and an optimal amount of distortion correction deviates from a value at a standard print speed. The conveying speed is often changed to cope with special print sheets such as an OHP sheet and the like or a change in thickness of print sheets if the print density remains the same. In such case as well, distortions change under the influence of a change in conveying speed.

Japanese Patent Laid-Open No. 11-352744 discloses a technique that controls the conveying speed of a print sheet and corrects distortions of an image.

However, when the scan density is changed by controlling the conveying speed of a print sheet, appropriate correction cannot be applied unless the scan line switching position is controlled. That is, when a scan line is switched at a predetermined pixel position, an image to be output (formed) becomes discontinuous at the selection point of the scan line, thus disturbing smooth drawing.

### SUMMARY OF THE INVENTION

The present invention has been made in consideration of the aforementioned problems, and has as its object to output a high-quality image by executing correction processing according to the operation condition of an image forming apparatus.

According to one aspect of the present invention, there is provided an image data creation method in an information processing apparatus, comprising steps of:

setting an operation condition of a print unit;

generating image data having undergone distortion correction by using distortion correction information corresponding to the set operation condition; and

transmitting the generated image data and information of the operation condition to the print unit.

According to another aspect of the present invention, there is provided an information processing apparatus for creating image data, comprising:

a setting unit adapted to set an operation condition of a print unit;

a generation unit adapted to generate image data having undergone distortion correction by using distortion correction information corresponding to the set operation condition; and

a transmission unit adapted to transmit the generated image data and information of the operation condition to the print unit.

According to the present invention, a high-quality image can be output by executing correction processing according to the operation condition of an image forming apparatus.

Further features of the present invention will become apparent from the following description of exemplary embodiments with reference to the attached drawings.

### BRIEF DESCRIPTION OF THE DRAWINGS

FIG. 1 is a view for explaining the arrangement of an image forming apparatus according to the first embodiment;

FIG. 2 is a view for explaining the trails of a laser beam with which the surface of a photosensitive drum is irradiated;

FIG. 3 illustrates a change in trail of the laser beam due to a tilt between a scan surface and the rotational axis of the photosensitive drum;

FIG. 4 is a block diagram for explaining the basic arrangement of a correction unit for executing distortion correction, and the image forming apparatus;

FIG. 5 is a block diagram for explaining the arrangement of a correction circuit;

FIGS. 6A and 6B are views for explaining switching of scan lines;

FIG. 7 is a block diagram for explaining the arrangement of a correction information generator;

FIG. 8 is a flowchart for explaining the sequence of processing of the image forming apparatus according to the first embodiment;

FIG. 9 is a flowchart for explaining the sequence of processing of an image forming apparatus according to the second embodiment;

FIGS. 10A and 10B show practical examples of correction processing in rendering processing of an image; and

FIG. 11 shows tables showing, as the operation conditions of the image forming apparatus, a combination of coordinate information of each correction position and information of an amount of correction, and selection information linked with coordinate information taking the conveying velocities of a print sheet as an example.

### DESCRIPTION OF THE EMBODIMENTS

Preferred embodiments of the present invention will be described in detail hereinafter with reference to the accompanying drawings. Note that components described in these embodiments are merely examples, and the technical scope of the present invention is defined by the appended claims but it is not limited by each individual embodiment to be described hereinafter.

### First Embodiment

### Explanation of Image Forming Apparatus

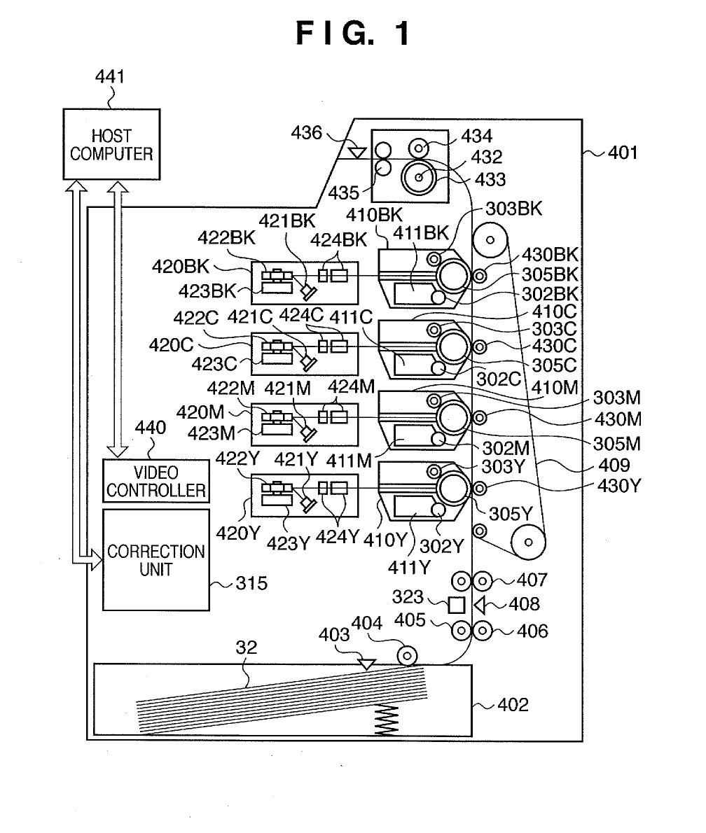

FIG. 1 shows an example of the arrangement of a print unit of an image forming apparatus (to be also referred to as a “color laser printer” hereinafter) according to this embodiment. A color laser printer 401 has a deck 402 that stores print sheets 32, and includes a deck paper sensor 403 for detecting the presence/absence of print sheets 32 in the deck 402. The color laser printer 401 has a pickup roller 404 for picking up a print sheet 32 from the deck 402, and a deck feeding roller 405 for conveying the print sheet 32 picked up by the pickup roller 404. Furthermore, the color laser printer 401 has a retardation roller 406 which forms a pair with the deck feeding roller 405 and is used to prevent multiple feeding of print sheets 32.

On the downstream side of the deck feeding roller 405, a registration roller pair 407 for synchronously conveying the print sheet 32, and a pre-registration sensor 408 for detecting the convey state of the print sheet 32 to the registration roller pair 407 are arranged. On the downstream of the registration roller pair 407, an electrostatic adsorptive feeding transfer belt (to be abbreviated as “ETB” hereinafter) 409 is arranged. On the ETB 409, image forming units which respectively include process cartridges 410 (Y, M, C, and Bk) for four colors (Y, M, C, and Bk) and scanner units 420 (Y, X, C, and Bk) are arranged to form images. The formed images are overlaid on each other in turn by transfer rollers 430 (Y, M, C, and Bk), thus forming a full-color image, which is transferred onto the print sheet 32 and is conveyed.

On the downstream side, a fixing roller 433 including a heater 432 for heating, and a pairing pressure roller 434, are arranged so as to fix a toner image transferred onto the print sheet 32 by heat. Furthermore, a fixing exhaust roller pair 435 for conveying the print sheet 32 from the fixing roller, and a fixing exhaust sensor 436 for detecting the convey state from a fixing unit are arranged.

Each scanner unit 420 includes a laser unit 421, a polygon mirror 422 and scanner motor 423 used to scan a laser beam from that laser unit 421 onto an image carrier (to be referred to as a “photosensitive drum” hereinafter) 305, and an imaging lens group 424. Note that a laser beam emitted by the laser unit 421 is modulated based on an image signal output from a video controller 440.

Each process cartridge 410 comprises the photosensitive drum 305, a charging roller 303, a developing roller 302, and a toner container 411, which are required for an electrophotographic process. Each process cartridge 410 is detachable from the color laser printer 401.

A drawing distortion due to a laser beam with which the photosensitive drum 305 is irradiated based on image data (first image data) can be corrected by a correction unit 315. The correction unit 315 will be described later.

(Explanation of Drawing Distortion)

A drawing distortion includes nonlinear and linear distortion components. The nonlinear and linear distortions will be described below.

(Nonlinear Distortion)

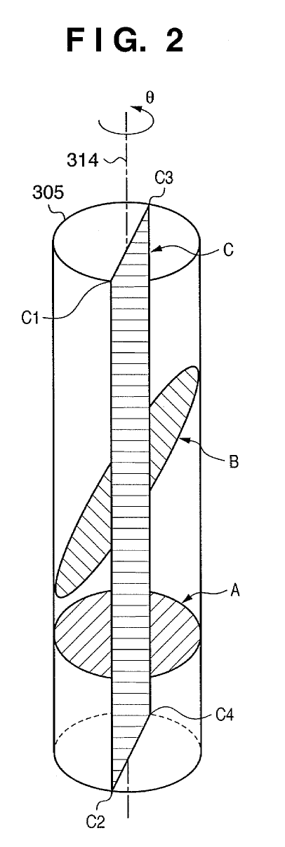

The drawing nonlinear distortion due to a laser beam will be described below. FIG. 2 is a view for explaining the trails of a laser beam with which the photosensitive drum 305 is irradiated. A latent image is formed by scanning a laser beam in the direction of a rotational axis 314 (main scanning direction) of the photosensitive drum 305. When the scan surface on the photosensitive drum 305 and the rotational axis 314 are not parallel to each other, the trail of the laser beam drawn on the surface of the photosensitive drum 305 upon rotation of the photosensitive drum 305 does not form a straight line but forms a curve. For example, a trail from c1 to c2 forms a straight line. When a laser beam scans a different scan surface upon rotation of the photosensitive drum 305, for example, a trail from c3 to c4 forms a straight line. A region c1c2c3c4 forms a rectangular trail C.

However, when the photosensitive drum 305 is attached to have a tilt with respect to the rotational axis 314, a trail of drawing of a laser beam upon rotation of the photosensitive drum 305 becomes an elliptic trail B. When the tilt of the photosensitive drum 305 with respect to the rotational axis 314 becomes a relative maximum, a circular trail A perpendicular to the rotational axis 314 is formed.

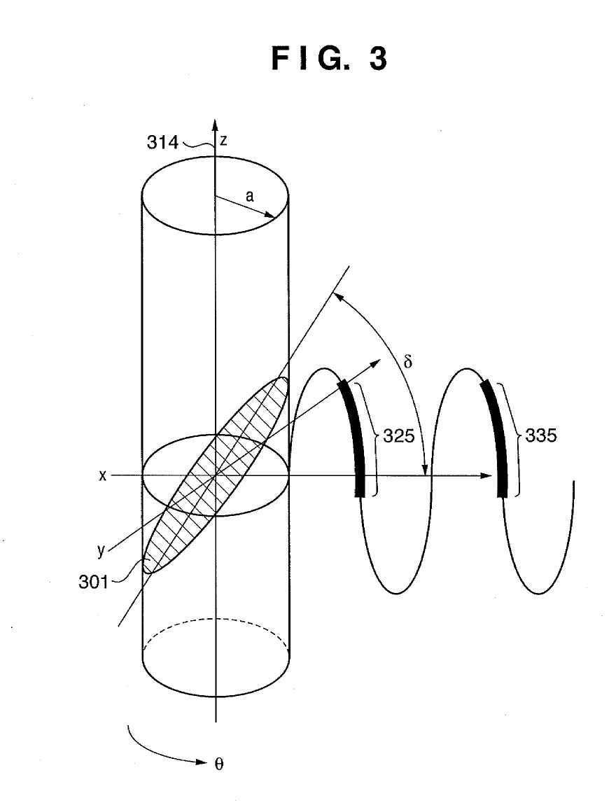

FIG. 3 illustrates a change in trail of a laser beam due to a tilt between the scan surface and the rotational axis 314 of the photosensitive drum 305. Assume that the rotational axis 314 of the photosensitive drum 305 is defined as a z-axis (main scanning direction), an axis which agrees with the conveying direction of a print sheet is defined as a y-axis, and a direction perpendicular to the conveying direction of a print sheet is defined as an x-axis. Let a be the radius of the photosensitive drum 305, and δ be the angle of an inclined plane 301. The origin of a cylindrical coordinate system is given by:

z=(sin δ/cos δ)y (3)

An equation of a circle as a vertical section of the photosensitive drum 305 meets:

x²+y²=a² (4)

y=a·sin θ, x=a·cos θ (5)

If the surface of the photosensitive drum 305 is transferred onto a plane without any deviation, a corresponding coordinate system on a print sheet with respect to a rotational angle θ of the photosensitive drum 305 is given as a function (θ, z) of the rotational angle θ and z-coordinate.

Upon substitution of y=a·sin θ of equations (5) into equation (3), z is given by:

z=a(sin δ/cos δ)·sin θ (6)

Since a laser beam does not reach the backside of the scan surface of the photosensitive drum 305, the trail of a scan of the laser beam formed upon rotation of the photosensitive drum 305 has shapes obtained by clipping parts of a trigonometric function (sine wave), as indicated by bold parts 325 and 335 of FIG. 3. That is, the trail of the scan of the laser beam is nonlinear, as described by equation (6).

(Linear Distortion)

A linear distortion will be described below. In a conveying system in the image forming apparatus, a linear distortion (offset) which can be approximated by the form of a linear function is generated at the scan start and end points of a laser beam. In general, the offset does not become larger than one pixel even at the terminal end of a scan upon scanning a laser beam using a single laser light source. However, in case of a multi-beam scan using a plurality of laser light sources, the offset may become large while being superposed in proportion to the number of beams.

A drawing distortion generated in the conveying direction (y-direction) of a print sheet can be expressed by superposition of a component f(z) of a linear distortion and a component kz of a nonlinear distortion, that is, by:

y=f(z)+kz (7)

(Explanation of Basic Arrangement of Image Processing Unit)

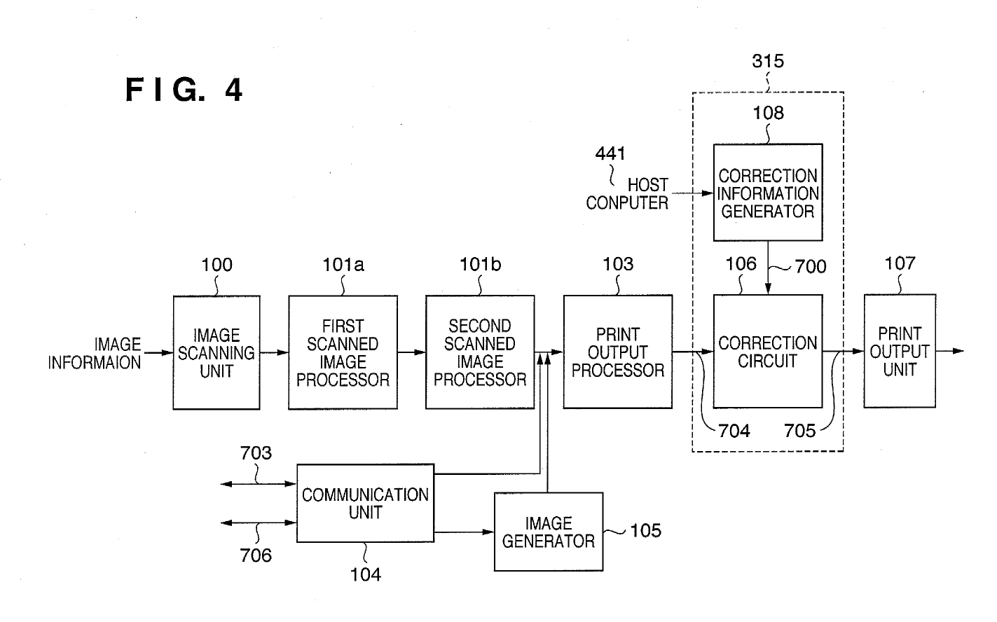

FIG. 4 is a block diagram for explaining the basic arrangement of the correction unit 315 which executes distortion correction, and the image forming apparatus. The correction unit 315 according to this embodiment can cope with correction of not only a linear distortion but also a nonlinear distortion expressed by a trigonometric function, as described above. The correction unit 315 can correct linear and nonlinear distortions in accordance with the operation conditions of the image forming apparatus (for example, the operation conditions including a copy operation, printer operation, or FAX operation, the conveying speed of a print sheet, print resolution, and the type of print sheet (glossy paper, plain paper, OHP, and the like)).

The image forming apparatus of this embodiment performs ideal rendering devoid of any distortion and stores image data in a memory (line buffer), and a correction circuit 106 in the subsequent correction unit 315 executes distortion correction. This arrangement requires addition of hardware. However, since a load upon considering distortion processing in rendering processing of the image forming apparatus can be reduced, high-speed rendering processing can be implemented, and the print mechanism and image forming unit can have a higher degree of independence.

Referring to FIG. 4, an image scanning unit 100 executes processing for converting image information of an original into an electrical signal. Note that the image scanning unit 100 is a part of a scanner (not shown) connected to the image forming apparatus shown in FIG. 1. Density information of an original is converted into an electrical signal indicating its strength, and is further digitized into a digital signal. Image information which is originally area information is converted into a density signal for each small area, that is, pixel density information.

A first scanned image processor 101a applies signal processing such as noise removal, adjustment of a dynamic range, and the like to the converted pixel density information, so that the information can be easily handled in the subsequent image processing.

A second scanned image processor 101b of the next stage analyzes the scanned image, and estimates and reconstructs originally appropriate image information from a density change pattern of neighboring pixels around a pixel to be processed. The second scanned image processor 101b selects image processing to be applied based on the characteristics of a neighboring region to each pixel, executes appropriate image processing according to the characteristics of the neighboring region, and can append attribute information. Note that the appropriate image processing includes processing for emphasizing or smoothing an edge according to the type of region. The attribute information is information indicating that a pixel to be processed belongs to one of a character, photo, and halftone dot. The second scanned image processor 101b can execute image processing corresponding to the operation as a printer, that as a FAX, and the like in addition to the copying operation.

A communication unit 104 communicates with an external apparatus. The communication unit 104 outputs image information received from a network 703 to an image generator 105 or print output processor 103. In case of a FAX operation, the communication unit 104 can receive and transmit FAX data via a public line 706.

The communication unit 104 can directly receive image information in some data formats, or can receive data in the format of a print description language when the image forming apparatus serves as a printer.

In order to realize the operation as a printer, FAX operation, and the like, the image forming unit has the image generator 105. The image generator 105 generates an image in accordance with a print description language and the like from an external apparatus such as an information processing apparatus (computer) or the like, and outputs the generated image to the print output processor 103.

The print output processor 103 converts the image information (multi-valued image information) received from the second scanned image processor 101b or image generator 105 into an image that matches the characteristics of a print output unit. In general, since the image forming apparatus hardly directly expresses tone information, multi-valued image information needs to be converted into area tone expression by halftone processing and the like. The print output processor 103 converts image information into area tone expression that matches the characteristics of a print output unit 107. The multi-valued image information input to the print output processor 103 is converted into image data of tone expression based on the area ratio of a print part and non-print part of small regions. Image data 704 processed by the print output processor 103 is input to the correction circuit 106 of the correction unit 315. The correction unit 315 comprises the correction circuit 106 and a correction information generator 108 as components. Data 705 corrected by the correction circuit 106 is input to the print output unit 107, and is printed out by the print output unit 107.

The correction information generator 108 can combine and hold (store) coordinate information where correction of a distortion is to be applied according to the position in the main scanning direction (coordinate information of a correction position) and information of a correction amount corresponding to the coordinate information as a pair. Furthermore, the correction information generator 108 can hold (store) selection information indicating a line buffer to be selected of a plurality of line buffers that store image data continuous in the sub-scanning direction to be linked with the coordinate information indicating the position where correction is to be applied.

The coordinate information of the correction position and the information of the correction amount individually correspond to information of the operation conditions of the image forming apparatus, for example, the copy operation, printer operation, or FAX operation, the conveying speed of a print sheet, print resolution, and the type of print sheet (glossy paper, plain paper, OHP, and the like).

The coordinate information and information of the correction amount are obtained when the image forming apparatus forms images without distortion correction under various operation conditions, and detects distortion amounts at that time. This detection may be made in a factory that manufactures the image forming apparatus or by a service person who sets the image forming apparatus. The coordinate information and information of the correction amount are calculated from the detected distortion amounts, and are written in a correction coordinate table and correction amount table to be described later.

When the operation conditions of the image forming apparatus are designated, the correction information generator 108 selects the coordinate information of the correction position and information of the correction amount corresponding to the operation conditions. Also, the correction information generator 108 selects the selection information of the line buffer linked with the coordinate information.

The correction information generator 108 generates control information 700 used to control the correction circuit 106 based on the selected coordinate information, information of the correction amount, and selection information. This control information 700 includes the selection information linked with the coordinate information, and the information of the correction amount corresponding to the coordinate information.

(Arrangement of Correction Information Generator 108)

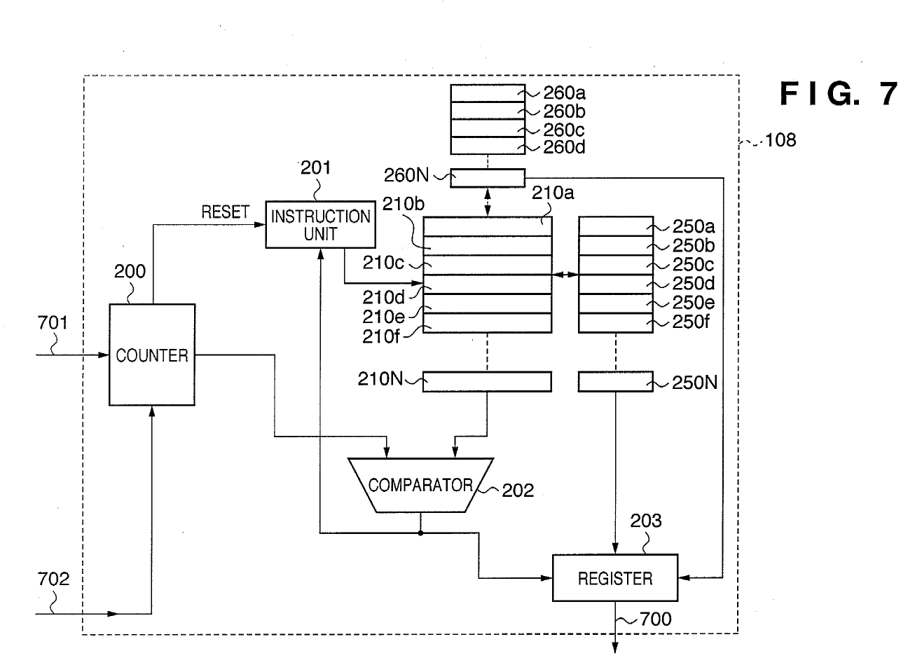

The arrangement of the correction information generator 108 will be described below with reference to FIG. 7. A counter 200 counts up pixel by pixel in accordance with an input pixel clock 701 to specify the pixel position in the main scanning direction. The value of the counter 200 is cleared in response to a sync signal 702 in the main scanning direction, and is counted up pixel by pixel for each scan line, thereby specifying the pixel position in the main scanning direction. Correction coordinate tables 210a to 210N store coordinate information for respective pixels used to specify the coordinate position of a correction position where correction is applied.

An instruction unit 201 selects data (coordinate information) corresponding to the current pixel position in the main scanning direction input from the counter 200 from the correction coordinate tables. Data are stored in the correction coordinate tables 210a to 210N while being sorted in ascending order. The instruction unit 201 has a pointer used to designate a correction coordinate table, and can sequentially select the correction coordinate tables 210a to 210N by incrementing the designated value of the pointer.

Correction amount tables 250a to 250N store pieces of information of correction amounts, and are paired with the correction coordinate tables 210a to 210N. Selection information tables 260a to 260N store pieces of selection information used to designate selection of a line buffer, and are linked with the correction coordinate tables 210a to 210N. To attain appropriate correction process, the correction coordinate tables, correction amount tables, and selection information tables are set in accordance with the operation conditions of the image forming apparatus, for example, the copy operation, printer operation, or FAX operation, the conveying speed of a print sheet, print resolution, and the type of print sheet (glossy paper, plain paper, OHP, and the like).

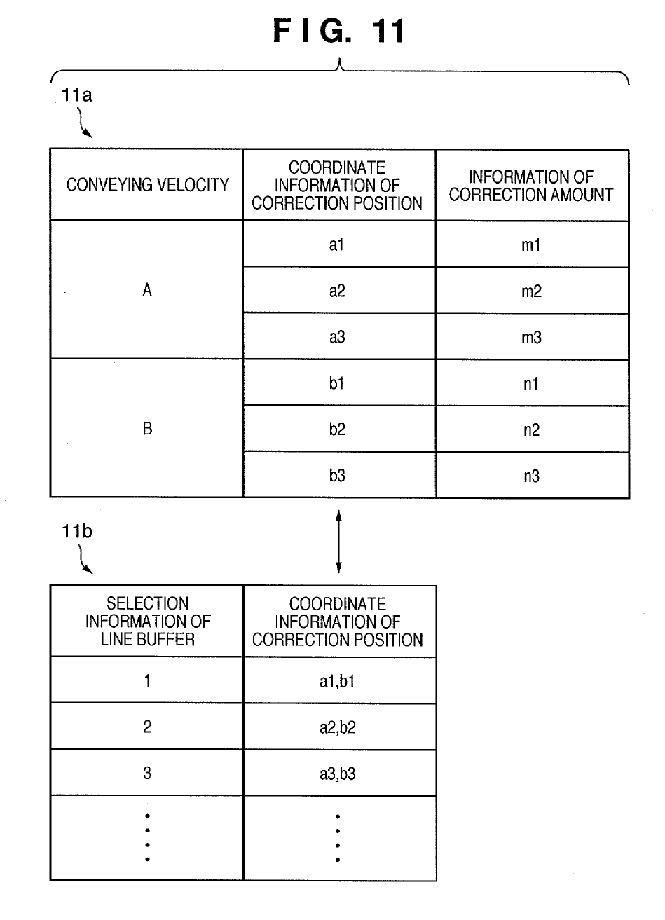

FIG. 11 shows tables showing a combination of coordinate information of each correction position and information of a correction amount (a of FIG. 11), and selection information linked with coordinate information (b of FIG. 11) taking the conveying velocities (A, B) of a print sheet as an example of the operation conditions of the image forming apparatus. Assume that the conveying velocities of a print sheet are A and B as different operation conditions.

In case of conveying speed A, pieces of coordinate information (those of correction positions) where a distortion in the main scanning direction generated by scanning of a laser beam is to be corrected are a1, a2, and a3 (pixels). For example, m1 is stored as information of a correction amount corresponding to the coordinate informational (pixel) of the correction position. Also, m3 is stored as information of a correction amount corresponding to the coordinate information a3 (pixel) of the correction position. Likewise, in case of conveying speed B, pieces of coordinate information of correction positions are b1, b2, and b3 (pixels). n1 to n3 are stored as pieces of information of correction amounts corresponding to the pieces of coordinate information b1 to b3 of the correction positions. Assume that a1 is different from b1. Likewise, assume that a2 and a3 are different from b2 and b3.

A comparator 202 compares the coordinate information stored in the correction coordinate table selected by the instruction unit 201 with the current coordinate information. If the two pieces of coordinate information match based on the comparison result, the comparator 202 determines that switching processing of a scan line (correction processing) is required. In this time, the value of the correction amount table corresponding to the currently selected correction coordinate table is input to a register 203.

Also, selection information corresponding to the coordinate information is input to the register 203.

At the same time, the comparator 202 updates the pointer of the instruction unit 201 to select a correction coordinate table which stores the next largest coordinate information to that stored in the currently selected correction coordinate table.

Since the pointer update processing or the like requires processing for each pixel, high-speed processing is required. Therefore, in order to hold only minimum required information in the tables, the coordinate information, information of the correction amount, and selection information corresponding to the designated operation conditions may be selected, and may be set in the respective tables of the correction information generator 108. For example, pieces of information to be set in the correction coordinate tables, correction amount tables, and selection information tables are downloaded from a host computer 441 to rewrite data corresponding to the operation conditions.

The register 203 holds information of a new correction amount at the correction coordinate position, and selection information used to select a line buffer. The pieces of information held by the register 203 are input to the correction circuit 106 as the control information 700.

(Arrangement of Correction Circuit 106)

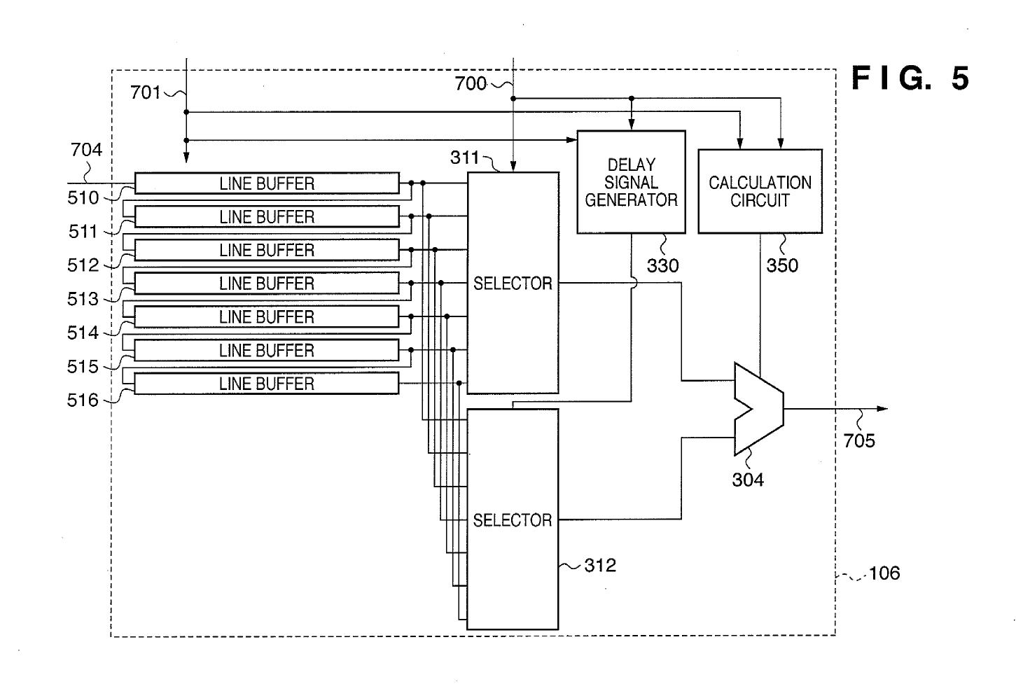

The detailed arrangement of the correction circuit 106 will be described below with reference to FIG. 5. The correction circuit 106 receives the image data 704 processed by the print output processor 103. Note that the image data input to the correction circuit 106 is image data rendered as ideal data free from any distortion, and is stored in turn in a plurality of line buffers 510 to 515. The line buffers can be arranged in correspondence with the number of scan lines irradiated with a laser beam. The plurality of line buffers are switched in turn. The line buffers are selected by selectors 311 and 312 based on the control information 700.

More specifically, the position of the current pixel to be processed in the main scanning direction in the image data 704 and the aforementioned correction position determined based on the operation conditions of the image forming apparatus are compared. If the position of the current pixel to be processed in the main scanning direction matches the correction position, image data using a pixel one line above or below the pixel to be processed is output.

Note that this image data to be output may be expressed by an intermediate density to be described later.

The selector 311 of the correction circuit 106 can control the output (read-out) timings of an image data sequence stored in the line buffers 510 to 515 based on the control information 700 output from the correction information generator 108. The control information 700 is also input to a delay signal generator 330. The delay signal generator 330 generates a delay signal (delay amount) used to control the selector 312 based on the input control information 700 including the information of the correction amount, and outputs the generated delay signal to the selector 312. The delay signal (delay amount) includes the selection information included in the control information 700, and the selector 312 selects a line buffer from which image data (second image data) is to be read out based on the selection information.

The selector 312 can control the output (read-out) timings of image data stored in the respective line buffers based on the delay signal (delay amount) output from the delay signal generator 330.

The output timing of the image data output from the selector 312 is delayed from that output from the selector 311 by the delay signal (delay amount).

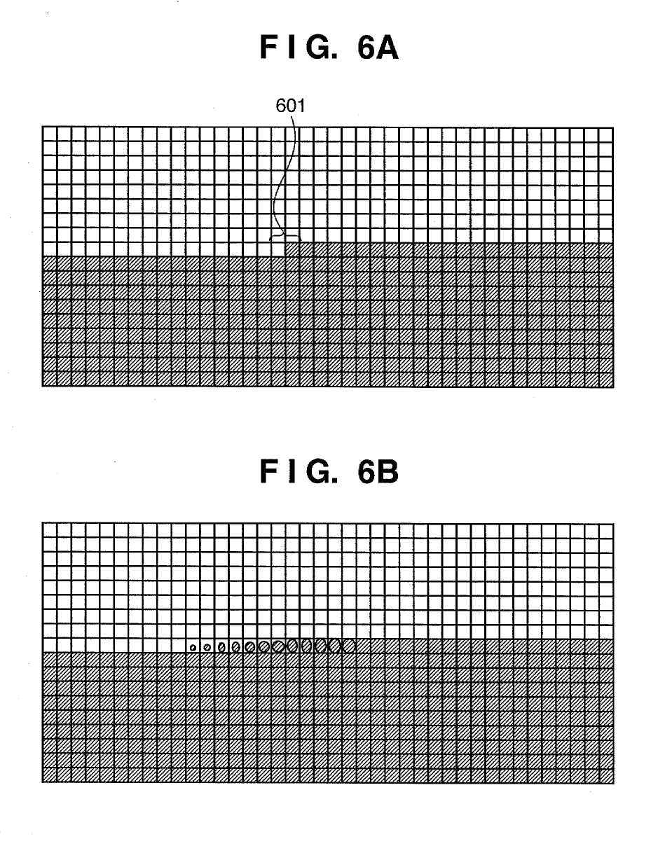

Upon simply switching the line buffers, a distortion is eliminated compared to a case in which the line buffers are not switched. However, a step (coordinate deviation) is generated near a switching point due to switching of scan lines, as denoted by reference numeral 601 in FIG. 6A, and a distortion visually stands out. The correction circuit 106 executes correction processing (smoothing processing) for gradually performing switching, as shown in FIG. 6B, so as to visually obscure the coordinate deviation.

More specifically, the correction circuit 106 generates intermediate density information from two pieces of density information of image data (first image data) before switching and that (second image data) after switching. The correction circuit 106 then gradually switches a weight from the image data before switching to that after switching.

In order to realize switching of the weight of image data, the correction circuit 106 has two selection units (selectors) of the outputs of the line buffers.

The selectors 311 and 312 select one line buffer from the plurality of line buffers 510 to 515 based on the control information 700 and the delay signal (delay amount), and read out image data (second image data).

A calculation circuit 350 calculates a weight value to be added to the image data before switching. The calculation circuit 350 calculates (generates) a weight value from the control information 700 and pixel clock 701, and controls an addition unit 304. The addition unit 304 adds the weight value calculated (generated) by the calculation circuit 350 to the image data output from the selector 411, and outputs corrected data 705 to the print output unit 107.

The addition unit 304 serves as an output unit which outputs image data (first image data) added with the weight value before output of image data (second image data) selected by the selector 312.

(Processing Upon Print Operation)

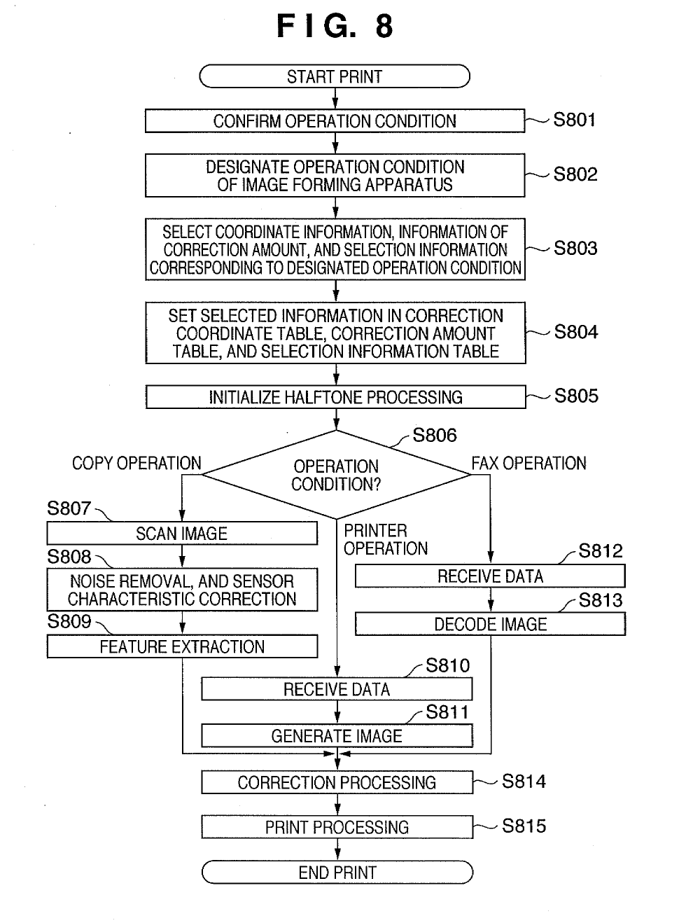

The sequence of processing upon the print operation by the image forming apparatus will be described below with reference to the flowchart of FIG. 8. In step S801, the operation conditions of the image forming apparatus are confirmed. The user designates the operation conditions (for example, the copy operation, printer operation, or FAX operation, the conveying speed of a print sheet, print resolution, type of print sheet, and the like) of the image forming apparatus in accordance with confirmation of the operation conditions, in step S802.

In step S803, the correction information generator 108 selects coordinate information of a correction position, information of a correction amount (optical correction coefficient), and selection information required to switch (select) the line butter corresponding to the designated operation conditions.

In step S804, the correction information generator 108 sets the coordinate information, information of the correction amount, and selection information in the correction coordinate tables, correction amount tables, and selection information tables.

In step S805, initialization for halftone processing is executed.

The operation conditions designated in step S802 are checked in step S806. If the copy operation is designated, the process advances to step S807. If the printer operation is designated, the process advances to step S810. If the FAX operation is designated, the process advances to step S812.

If the copy operation is designated, the image scanning unit 100 scans an image in step S807. In step S808, noise removal and correction of the sensor characteristics are executed. In step S809, the second scanned image processor 101b executes feature extraction. The process then advances to step S814.

If the printer operation is designated, the communication unit 104 receives data from the host computer 441 in step S810. In step S811, the image generator 105 generates an image in accordance with a print description language or the like from the external apparatus such as the host computer 441 or the like. The process then advances to step S814.

If the FAX operation is designated, the communication unit 104 receives data in step S812. In step S813, an image is decoded. The process then advances to step S814.

In step S814, the correction circuit 106 generates intermediate density information, and executes correction processing. In step S815, the print output unit 107 executes print processing of the data 705 corrected in step S814.

According to this embodiment, since the correction processing is executed according to the operation conditions of the image forming apparatus, a high-quality image can be output.

### Second Embodiment

In the first embodiment, the correction unit 315 (correction circuit 106, correction information generator 108) and software for controlling this unit can be implemented in the image forming apparatus.

However, in an image forming apparatus with low hardware cost, no hardware components such as scanning and drawing mechanisms and the like are implemented, and all drawing processes are executed by the host computer. Final image data is received by the image forming apparatus, and can be output from the print output unit 107.

In this embodiment, generation of image data to which an information processing apparatus (host computer) applies correction processing based on coordinate information and information of a correction amount acquired from the image forming apparatus will be described.

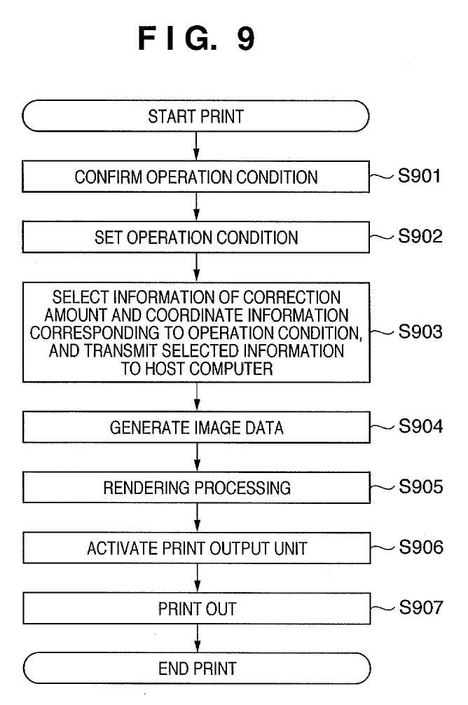

FIG. 9 is a flowchart for explaining the sequence of processing of an image forming apparatus according to the second embodiment. This processing is executed under the control of a CPU (not shown) of the host computer 441.

The image forming apparatus has no generation function of image data, but it comprises a communication unit which exchanges image data for driving the print output unit (print mechanism) 107 and control information with the host computer. The communication unit can receive data associated with settings of the operation conditions in addition to exchange of control signals required to control a normal print sequence.

In step S901, the host computer confirms the settings of the operation conditions, and transmits the operation conditions of the image forming apparatus to the image forming apparatus. For example, such as the first embodiment, the operation conditions of the image forming apparatus include the copy operation, printer operation, or FAX operation, the conveying speed of a print sheet, print resolution, type of print sheet, and the like. In step S902, the operation conditions received via the communication unit are set in the image forming apparatus.

In step S903, a correction information generator selects information of a correction amount (correction information of an optical distortion) and coordinate information to be corrected (scan line change coordinate position) corresponding to the set operation conditions. The communication unit transmits the selected information of the correction amount (correction information of an optical distortion) and coordinate information to be corrected (scan line change coordinate position) to the host computer. The host computer sets the information of the correction amount (correction information of an optical distortion) and coordinate information to be corrected (scan line change coordinate position) received from the image forming apparatus as reference data upon rendering.

In step S904, the host computer generates image data. In step S905, the host computer executes rendering processing in which image distortion correction is applied to the image data, as described in the first embodiment, with reference to the information of the correction amount (correction information of an optical distortion) and coordinate information to be corrected (scan line change coordinate position) which are set as the reference data.

In step S906, upon completion of generation of the image data required to enable a print output unit of the image forming apparatus, the host computer transmits control signals required to control the print sequence. Upon reception of the control signals, the communication unit of the image forming apparatus activates the print output unit. A message indicating completion of activation of the print output unit is transmitted to the host computer via the communication unit.

In step S907, the host computer transmits the image data. The image data received via the communication unit of the image forming apparatus is output by the processing of the print output unit.

(Practical Example of Correction Processing)

In the correction processing, a character is handled as contour information to print a character of an arbitrary size. A straight line can be realized if it is drawn as an elongated rectangle. An arbitrary polygon can be divided into triangles, and a curve can be approximated by polygons that look nearly the same on a bitmap. Therefore, rendering processing of an arbitrary image can be reduced to a paint operation of the interior of a triangle.

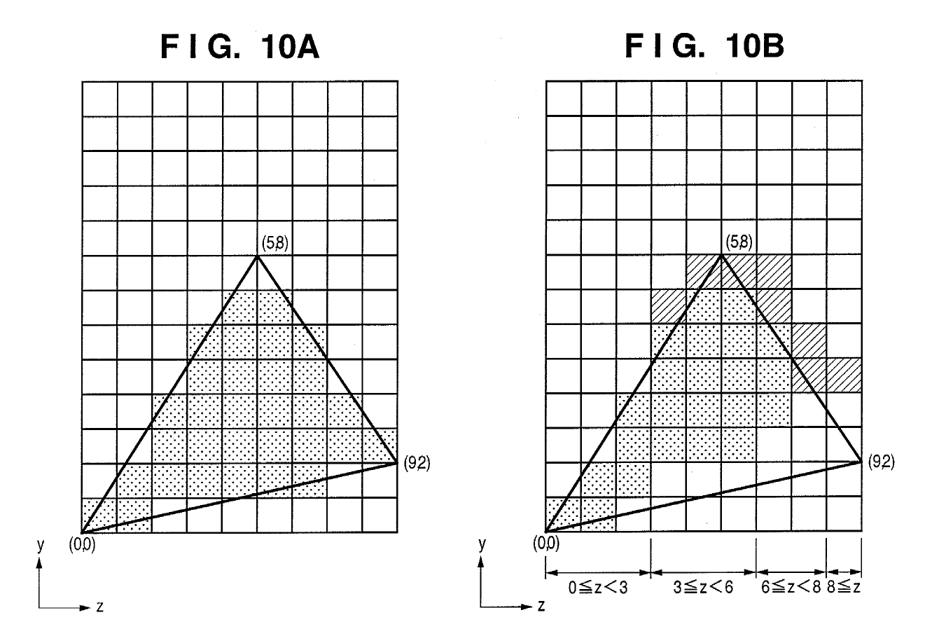

FIGS. 10A and 10B show practical examples of the correction processing in the image rendering processing. Assume that the main scanning direction agrees with the z-coordinate direction, and the sub-scanning direction perpendicular to the main scanning direction agrees with the y-coordinate direction. FIG. 10A will exemplify a case in which a distortion is generated in the y-direction.

When a non-corrected image is rendered, for example, when the interior of a triangle (z, y)=(0, 0)−(5, 8)−(9, 2) is painted, a hatched portion shown in FIG. 10A is painted.

FIG. 10B is a view for explaining rendering upon application of the correction processing. With reference to coordinate information and information of a correction amount, for example, if the correction amount is zero within the range 0≦z<3, no correction is made in the y-direction. Within this range, the same applies to the rendering shown in FIG. 10A. If the correction amount indicates one pixel within the range 3≦z<6, a hatched region obtained by adding +1 pixel in the y-direction and a halftone dot region (dot region) are set as a region to be painted.

If the correction amount indicates two pixels within the range 6≦z<8, a hatched region obtained by adding +2 pixels in the y-direction, and a halftone dot region are set as a region to be painted.

If one pixel is blank (not painted) and one pixel is corrected (painted) within the range 8≦z, the +1st pixel in the y-direction is set as a blank pixel, and the +2nd pixel is set as a region to be painted (a hatched region).

Normally, the paint processing is determined based on determination as to whether or not the coordinate position of each pixel falls within a region (triangle) to be rendered. The coordinate position which is determined to fall within the region (triangle) to be rendered is compared with the coordinate information. When a correction amount is set in correspondence with the coordinate information, the correction processing added with the correction amount is executed.

According to this embodiment, even in an image forming apparatus with a low-cost arrangement, since the host computer executes the correction processing, a high-quality image which reflects the correction processing according to the operation conditions of the image forming apparatus can be output.

### Other Embodiments

Note that the objects of the present invention are also achieved by supplying a computer-readable storage medium, which records a program code of software that can implement the functions of the aforementioned embodiments to a system or apparatus. Also, the objects of the present invention are achieved by reading out and executing the program code stored in the storage medium by a computer (or a CPU or MPU) of the system or apparatus.

In this case, the program code itself read out from the storage medium implements the functions of the aforementioned embodiments, and the storage medium which stores the program code constitutes the present invention.

As the storage medium for supplying the program code, for example, a flexible disk, hard disk, optical disk, magneto-optical disk, CD-ROM, CD-R, nonvolatile memory card, ROM, and the like may be used.

The computer executes the readout program code to implement the functions of the aforementioned embodiments. Also, the present invention includes a case in which an OS (operating system) running on the computer executes some or all of actual processing operations based on an instruction of the program code, thereby implementing the aforementioned embodiments.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-101046, filed Apr. 6, 2007, which is hereby incorporated by reference herein in its entirety.

What is claimed is:

1. An image data creation method in an information processing apparatus, comprising steps of:
setting an operation condition of a print unit;
generating image data having undergone distortion correction by using distortion correction information corresponding to the set operation condition; and
transmitting the generated image data and information of the operation condition to the print unit.

2. The method according to claim 1, wherein the operation condition is of setting a print sheet used in the print unit.

3. The method according to claim 1, wherein the operation condition is of setting a conveying speed of a print sheet used in the print unit.

4. The method according to claim 1, wherein the operation condition is of setting a print resolution in the print unit.

5. The method according to claim 1, wherein the information of the operation condition is transmitted to the print unit before the distortion correction information is acquired from the print unit.

6. An information processing apparatus for creating image data, comprising:
a setting unit adapted to set an operation condition of a print unit;
a generation unit adapted to generate image data having undergone distortion correction by using distortion correction information corresponding to the set operation condition; and
a transmission unit adapted to transmit the generated image data and information of the operation condition to the print unit.
